(19) United States
(12) Patent Application Publication
(10) Pub. No.: US 2002/0174036 A1
(43) Pub. Date: Nov. 21, 2002

(54) Method and system for fundraising including image transfer services

(76) Inventor: Timothy L. Coyle, Mason, OH (US)

Correspondence Address: SQUIRE, SANDERS & DEMPSEY L.L.P., Two Renaissance Square, 40 North Central Avenue, Suite 2700, Phoenix, AZ, 85004-4498, US

(21) Appl. No.: 09/863,792

(22) Filed: May 21, 2001

(51) Int. Cl. G06F 17/60

(52) U.S. Cl. 705/27

(57) ABSTRACT

The invention discloses methods and systems for fundraising through sale of merchandise incorporating images and/or photographs of events hosted or sponsored by a fundraising entity. In a preferred embodiment a method includes registering several fundraising entities, providing a viewable medium for the registered fundraising entities to post images, displaying on the viewable medium a selection of products available to have a selected posted image incorporated, providing an interface that a customer may view the posted images, selected a desired image for transferring, selected an available product to display the desired image and complete a sale. The invention also provides for accounting of profits for sold products and distributing profits to registered fundraising entities of from which images incorporated on sold products were selected. In a preferred implementation, the viewable medium includes a distributed computer environment communicating over the Internet.

### BACKGROUND

1. Field of the Invention.

The invention generally relates to methods and systems for fundraising, particularly to fundraising over the Internet through the creation of electronic photo albums and the sale of gift or commemorative items displaying images selected from those electronic photo albums on the Internet.

2. Related Art.

Conventionally, the general public is able to create electronic—or, online-photo albums, view those photo albums over the Internet, and make purchases of gifts or commemorative items—such as, for example, mugs, calendars, shirts, mouse pads, etc. on which one or more photos from those online photo albums are displayed. Among those companies that make such services available are Zing™(http://www.zing.com), Shutterfly™(http://www.shutterfly.com), PhotoPoint™(http://www.photopoint.com) and Photonet (a Kodak® Company), and several others. By way of example, a customer having Internet access may visit the zing.com web site, create an online photo album on that web site, upload a digital image to that web site and purchase from that web site a mug on which that digital image would be displayed.

Additionally, at least one Internet based company, iluvcamp.com, shares with its customers—namely, camps—revenues from the sales of photograph prints from online photo albums that these customers create on its web site.

However, currently, there is no easy, cost effective method or system by which fundraising organizations as a whole can capture photos of their events and occasions, immediately share those photos with a large audience of viewers, and share significantly not only in the revenues generated from the sale of their photos and of gift items on which their photos are displayed, but also in the revenues generated by sales of photos, and of gift items displaying photos, similarly captured and shared by other organizations and individuals.

### SUMMARY OF THE INVENTION

The present invention discloses methods and systems for fundraising through the utilization of image transfer services and the sale of gift and commemorative items. Methods of the present invention include uploading electronic—or, digital—images to an electronic medium—or, web site—enabling users to easily browse among and view those images, select desired images, view and select gift items from one or more electronic stores, and purchase the selected gift items with the selected images to be displayed thereon, with the revenues from such purchases being shared with one or more fundraising entities.

A system according to one example of the invention includes means for viewing and selecting desired images, means for viewing and selecting gift or commemorative items on which to display the desired images and means for allocating and distributing revenues to fundraising entities.

Computer systems and computer readable media having software for performing the methods of the present invention are also described.

### BRIEF DESCRIPTION OF THE DRAWING

Further aspects and advantages of the present invention will become apparent from the following description in reference to the appended drawing in which like numerals denote like elements and in which:

FIG. 1 is a flow chart illustrating a method for fundraising according to an exemplary embodiment of the present invention;

FIG. 2 is a block diagram illustrating a system for fundraising according to the present invention;

FIG. 3 is a flow chart illustrating a fundraising entity's interface with the methods and system of the present invention;

FIG. 4 is a flow chart illustrating an interface by customers with the methods and system of the present invention;

FIG. 5 is a flow chart illustrating a method for allocating and distributing revenues generated by the fundraising methods and systems of the present invention;

FIG. 6 illustrates an alternate method for allocating and distributing revenues generated by the fundraising methods and system of the present invention.

### DETAILED DESCRIPTION OF THE PREFERRED EMBODIMENTS

The preferred embodiments of the present invention describe Internet-based methods and systems by which a Web Service Provider facilitates the following image transfer services: (i) maintains a Web Site on a Web Server in which it stores Digital Images electronically transmitted to it from a remote computer by or on behalf of one or more Fundraising Entities; (ii) organizes those Digital Images within one or more Electronic Photo Albums administered by or on behalf of such Fundraising Entities; (iii) provides Customers with Internet access to such Electronic Photo Albums for purposes of both viewing the Digital Images contained therein and purchasing Personalized Gift Items from an Electronic Store maintained by the Web Service Provider on the Web Site; (iv) approves and processes payments for the purchased Personalized Gift Items and transmits orders for the same to one or Vendors; (v) shares the revenues generated by the sale of such Personalized Gift Items with the Fundraising Entity on whose behalf the applicable Electronic Photo Album was created; and (vi) provides each Fundraising Entity with Internet access to the Web Site for purposes of generating activity and sales reports for the Electronic Photo Albums which it administers, both individually and in the aggregate.

For purposes of this application, the capitalized terms used above and hereinafter shall have the following meanings:

Customer(s) means any client(s), customer(s) or other end user(s) of the Web Site, including any Fundraising Entity or members of Fundraising Entities;

Digital Image means any representation of one or more designs, drawings, portraits, paintings, photographs, structures and/or renderings thereof created in or converted to a digital format, and Digital Images means more than one Digital Image;

Electronic Photo Album(s) means any media container or partition enabling uploaded Digital Images to be segregated and/or displayed;

Electronic Store means any electronic medium on which the Personalized Gift Items may be displayed and ordered;

Fundraising Entity means any person, group of persons or organization desiring to generate finds either for itself or for and on behalf of any other person, group of persons or organization, and Fundraising Entities means, more than one Fundraising Entity, as used herein, a Fundraising Entity may also be a designated beneficiary of one or more individuals or organizations registered with the Web Service Provider;

Member(s) means any Fundraising Entity that has registered on the Web Site;

Personalized Gift Item means any gift or commemorative item on which Digital Images can be displayed or reproduced, including, without limitation, key chains, drinking mugs or steins, paper or cloth calendars, Christmas ornaments, magnets, mouse pads, pins, coasters, puzzles, tote bags, clocks, hats, shirts and other wearing apparel, playing cards, bookmarks, plates, post cards, stationary, balls and other sports equipment and photo prints, both framed and unframed, and Personalized Gift Items means more than one Personalized Gift Item;

Vendor(s) means any entity that may produce and ship Personalized Gift Items having selected images transferred thereon, and may include the Web Service Provider and/or the host of the Web Server;

Web Server means any computer system operating as a server computer and having or accessing a large memory and database for both storing Digital Images and processing and storing data related to the storage of the Digital Images, the viewing of Electronic Photo Albums and the purchasing of Personalized Gift Items, whether a single computer system and server or multiple servers and components thereof;

Web Service Provider means any person or entity then operating and maintaining the Web Site, and may include the owner of the Web Server and/or any Internet Service Provider (ISP), to facilitate the transfer of Digital Images onto Personalized Gift Items referred to herein as “image transfer services”; and

Web Site means any collection of web pages on which the methods and systems of the present invention may be performed.

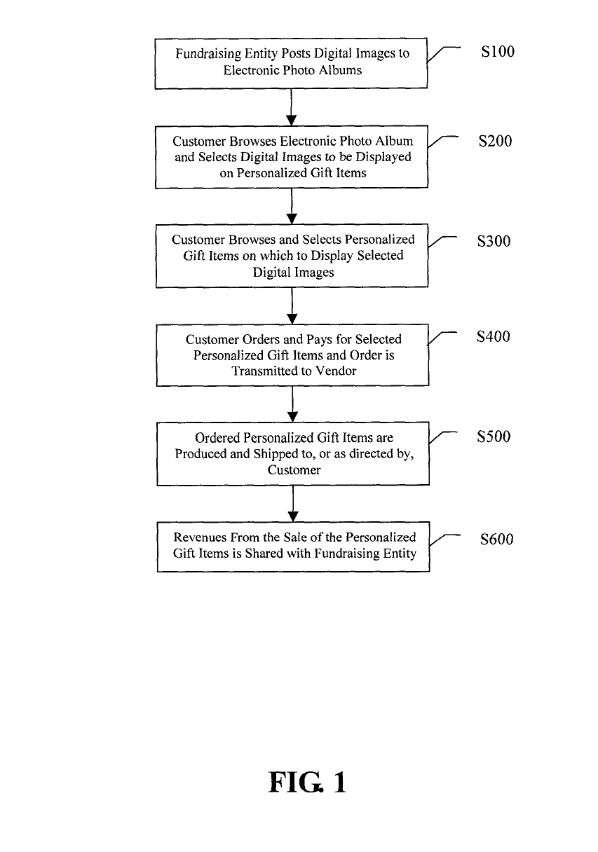

In a preferred method of the present invention, as shown in FIG. 1, a Web Service Provider provides Fundraising Entities access to a Web Site to which such Fundraising Entities may transmit Digital Images for storage and display in Electronic Photo Albums and on which the Web Service Provider maintains an Electronic Store S100. Preferably, each Electronic Photo Album is one or more web pages generated as an HTML (Hypertext Markup Language) document or XML (Extensible Markup Language) file.

A Customer browses the Digital Images displayed within an Electronic Photo Album and selects one or more of such Digital Images S200. Such browsing and selecting of Digital Images may be performed through the use of a web browser such as Netscape® or the like.

Next, the Customer browses the Electronic Store and selects a Personalized Gift Item on which to display the selected Digital Images S300. Browsing and selecting among Personalized Gift Items may be, as with the viewing and selecting of Digital Images, also performed through the use of a web browser such as Netscape® or the like. Personalized Gift Items may be any item that has at least one surface suitable for having a Digital Image reproduced or displayed thereon. A non-exhaustive list of such Personal Gift Items includes: key chains, drinking mugs or steins, paper or cloth calendars, Christmas ornaments, magnets, mouse pads, pins, coasters, puzzles, tote bags, clocks, hats, shirts and other wearing apparel, playing cards, bookmarks, plates, post cards, stationary, balls and other sports equipment. Essentially, any personal, business or home accessory with a suitable surface may be adapted to display Digital Images and, thus, the present invention is not limited to the Personalized Gift Items specifically listed above.

At step S400, the Customer orders and pays for the selected Personalized Gift Items, and the order is transmitted electronically, either individually or batched with other orders, to one or more Vendors. Payment may be performed in any conventional manner, but, in the preferred embodiment utilizing electronic commerce over the Internet; the Customer enters appropriate credit card and shipping information. The purchased Personalized Gift Items are then produced by the Vendors and shipped to, or as otherwise directed by, the Customer S500. Revenues from the sale of Personalized Gift Items are shared with, or as otherwise directed by, the Fundraising Entity from whose Electronic Photo Album it was purchased S600. The Fundraising Entities sponsoring Electronic Photo Albums may at any time generate reports from the Web Server indicating, among other things, the viewing and/or sales activity on any one or more of their Electronic Photo Albums.

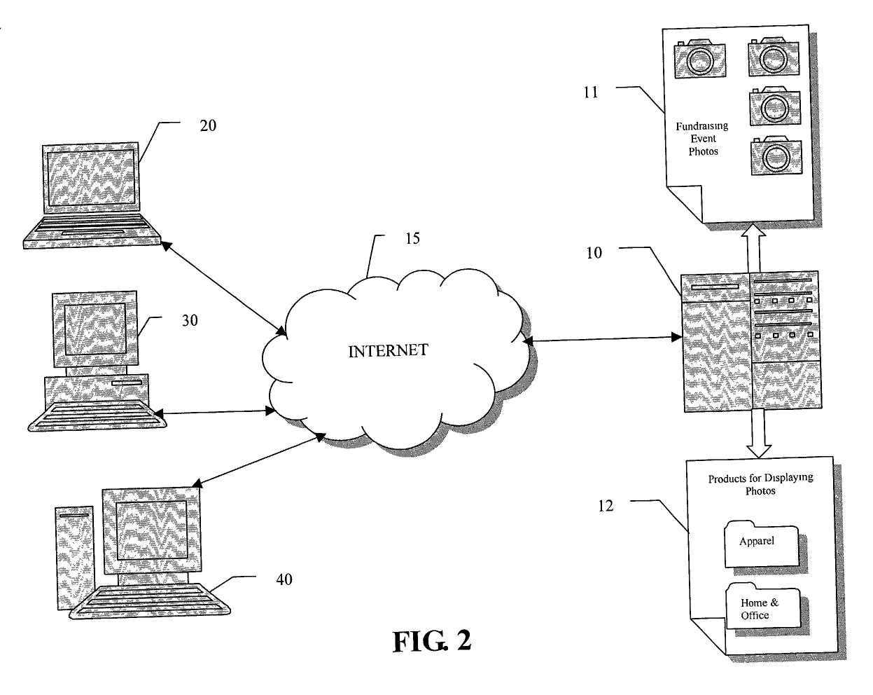

FIG. 2 illustrates a system through which Digital Images may be transmitted, stored and viewed, and Personalized Gift Items ordered, over the Internet. The Web Service Provider operates a Web Site on a Web Server, which Web Site is designed to store, or host, Electronic Photo Albums created by Fundraising Entities. The Web Server 10 is configured to operate with the protocols of the World Wide Web (WWW) and is coupled to the Internet 15. The Web Server 10 may be any computer system operating as a server computer and having or accessing a large memory and database for both storing Digital Images and processing and storing data related to the storage of the Digital Images, the viewing of Electronic Photo Albums and the purchasing of Personalized Gift Items. It should be appreciated that while the Web Server 10 is illustrated as one computer system, it may include additional servers and components as is well known in the art.

The Web Server 10 may either be owned and maintained by the Web Service Provider itself, or by an Internet Service Provider (“ISP”) to which the Web Service Provider subscribes. Similarly, the Web Site may either be owned and operated by the Web Service Provider or leased and operated by the Web Service Provider. The Web Service Provider may configure web pages, or uses web pages configured by others, for the Web Site using a conventional computer 40 (hereinafter called “administration terminal”) and commonly available web page authoring software. The administration terminal 40 is linked to the Web Server 10 through the Internet 15 to initially setup the web pages of the Web Site and to provide administration capabilities for a web site administrator or “webmaster” after the initial setup.

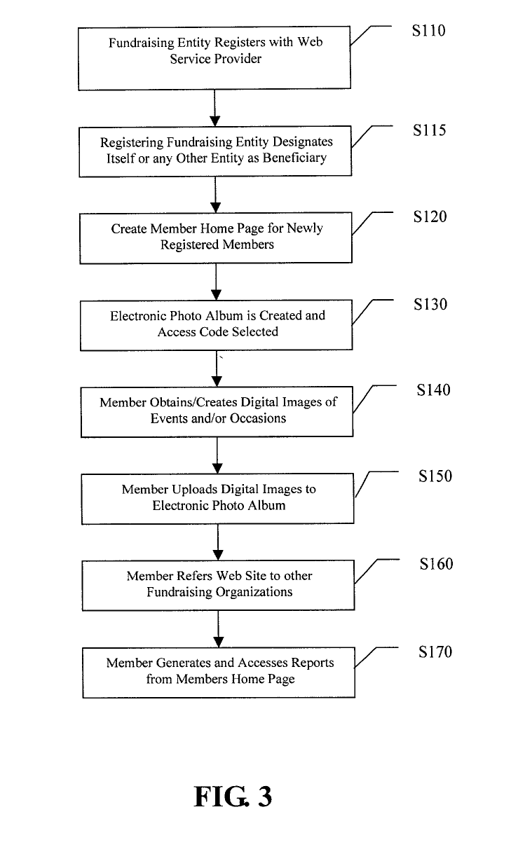

By way of example, FIG. 2 illustrates a Web Server 10 configured to host a Web Site having two different web pages 11 and 12. Web page 11 displays to Customers, within an Electronic Photo Album, Digital Images taken by or on behalf of a Fundraising Entity, and may, but need not, display to Customers a caption for some or all of such Digital Images. Web page 11 may be accessed from either a home page of the Web Site (not shown) or by hypertext link from another source. The Web Site home page preferably enables a Customer either to enter a specific code to gain access to a specific Electronic Photo Album or to perform a key word search that may lead to access to the desired Electronic Photo Album. Upon gaining access to an Electronic Photo Album, the Customer can then browse among the Digital Images contained therein. Consequently, there may be several web pages 11 within the Web Site, each of which is dedicated to a different Fundraising Entity. Posting of Digital Images by or on behalf of Fundraising Entities to their Electronic Photo Albums is described below in reference to FIG. 3.

Web page 12 contains images and/or textual descriptions of Personalized Gift Items available for purchase by Customers, which images and descriptions collectively comprise the Electronic Store. This Electronic Store may be accessed either (1) from the home page and/or other pages of the Web Site (not shown) without first selecting a Digital Image, or (2) upon selecting a desired Digital Image (e.g., by clicking on the desired Digital Image or a hypertext link near the desired Digital Image).

Preferably, web page 12 includes a sample depiction of each available Personalized Gift Item with a representative image displayed thereon, the price of each Personalized Gift Item and a narrative description thereof. The Web Site of the present invention may also comprise additional web pages (not shown), including, without limitation, web pages for indicating to a Customer whether a pre-selected Digital Image will fit on the selected Personalized Gift Item, for inputting payment and shipping information, and for enabling Fundraising Entities to register as Members, create or edit Electronic Photo Albums.

Internet 15 may be any combination of wired and wireless networks, including local area networks (LANs), intranets and the like using various network protocols that are well known in the art. Internet 15 provides each of the three (3) potential users of the Web Site—namely, Customers, Fundraising Entities and the webmaster or other system administrator—with access to the Web Server 10.

FIG. 2 illustrates three (3) computers 20, 30 and 40 interfacing Internet 15 for accessing the Web Site on the Web Server 10, one representing each category of user of the Web Site. Different computers are illustrated merely to differentiate among the three (3) categories of users of the Web Site. In actuality, many more computers are present and any one user/computer may engage the Web Site in any of the three (3) user capacities.

As shown, a computer 20 (referred to hereinafter as a “user terminal”) is used for Customer access to the Web Site hosted on the Web Server 10 via the Internet 15. User terminal 20 may be any type of processing device capable of displaying a web page in text or graphics format, including but not limited to, a desktop computer, a laptop or palmtop computer, a personal digital assistant (PDA), a cellular phone and Web TV™. A Customer utilizes terminal 20 to browse and select Digital Images and/or Personalized Gift Items.

Additionally, a computer 30 (referred to hereinafter as an “organization terminal”) is provided for Fundraising Entities to access the Web Site hosted on the Web Server 10. Organization terminal 30 is a processing device similar to user terminal 20 (in fact it may be the same device). The difference between the user terminal and organization terminal in interfacing with the Web Site is the type of access and features that may be performed. For example, as illustrated in FIG. 3, a Fundraising Entity seeking to utilize the services of the Web Service Provider must first complete a registration process S110. The registration process is preferably performed on a web page (not shown) on the Web Site and requires or requests that the Fundraising Entity provide various identifying information, including, without limitation, its name, description, address, phone and facsimile numbers, email address (or other user name) and password.

In the preferred embodiment, the registering Fundraising Entity has the option of designating either itself or any other Fundraising Entity as the organization for which it is seeking to raise funds S115.

Upon successful completion of the registration process, a web page is created S120 on the Web Site that serves as the private administration page (or, Member Home Page) for the newly registered Member. From its Member Home Page (and/or other pages accessed from the Member Home Page), the Member will have the password protected ability to perform a number of activities, including, without limitation, editing its registration information, creating, editing and otherwise administering its Electronic Photo Albums and accessing reports. An Electronic Photo Album is created by or on behalf of the Member S130 and an identifier (or, Access Code) is either assigned to or selected by the Member for that Electronic Photo Album. The Access Code may be any type of numeric and/or alphanumeric sequence of characters and is used by Customers in order to gain access to the Electronic Photo Album for purposes of viewing the Digital Images contained therein and ordering Personalized Gift Items therefrom.

It should be understood that the term Electronic Photo Album describes any type of media container or partition for segregating Digital Images uploaded by a Member to the Web Site. Accordingly, Electronic Photo Album, as used herein, is not limited to posting or displaying of any particular type of Digital Image, but rather any one or more types of Digital Images as that term is defined above. Moreover, a Member may create and manage any number of Electronic Photo Albums, each of which may relate to any one or more events, occasions or other subject matter and may contain any number of subfolders. For example, an educational institution, or any department, club or other unit within that educational institution, may register as Member and create separate Electronic Photo Albums for, for example, class reunions, sporting events, dances, band or other camps, class trips, etc., and have subfolders in each such Electronic Photo Album classified by, for example, year of graduation. To that end, the present invention is not limited to any particular type of layout or organization of Digital Images as this will be determined from time to time taking into consideration such factors as: memory space available on the Web Server, aesthetics and volume of activity (e.g., number of Members, Electronic Photo Albums and Digital Images and frequency of Customer visits and purchases).

At this point, the Fundraising Entity is a registered Member and has created one or more Electronic Photo Albums. The Member can now begin collecting Digital Images (for example, by taking digital photographs at an event) S140 and uploading those Digital Images to its Electronic Photo Album(s) S150. Digital Images are uploaded, or posted, to the Electronic Photo Albums in any conventional manner. For example, pictures taken with a digital camera may be downloaded onto organization terminal 30 (FIG. 2) and transmitted over the Internet 15 to the Web Server 10 for posting to an Electronic Photo Album on the Web Site using FTP (file transfer protocol) or other well-known transfer protocols. Alternatively, hard copies of photographs may be scanned into digital format and then transmitted as Digital Images to the Electronic Photo Album. Hard copies of photographs may also be mailed by the Member to the Web Service Provider who will then scan them into digital format and posts them as Digital Images in the Electronic Photo Album specified by the Member. Digitized Images may also be emailed to the Web Service Provider as attachments.

Distribution and storage of personal media and presentation of photo albums may also be performed in accordance with the techniques described in U.S. Pat. No. 6,035,323 to Narayen et al. which is incorporated herein by reference.

Upon receipt of the Member's Digital Images by the Web Server 10, the Digital Images may be displayed in one or more Electronic Photo Albums (or folders contained therein) created by the Member on the Web Site. In the preferred embodiment, Digital Images are stored on a memory accessible by Web Server 10 (FIG. 2).

Upon the accessing by a Customer, Member, webmaster or other user of the Web Site using conventional techniques, the Digital Photos may be retrieved by the Web Server 10 and displayed in presentable form within Electronic Photo Albums on respective displays of computers 20, 30, 40 S140.

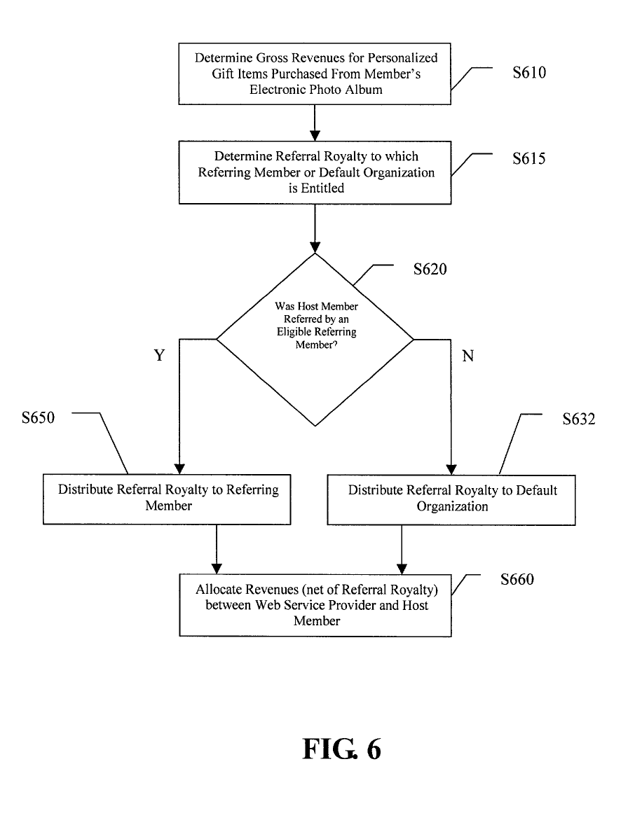

Once the Fundraising Entity is a registered as a Member, it may refer the Web Siteto other Fundraising Entities S160. The benefits to a referring Member for making such referrals are as discussed with reference to FIG. 6 below.

In the preferred embodiment, each Member may generate and access reports from its Member Home Page S170. The reports that may be generated and accessed by a Member may provide some or all of the following information, together with any other information that the Web Service Provider chooses to make available: summary or detail information relating to the number of visits to its Electronic Photo Albums; summary or detail information relating to sales from its own Electronic Photo Albums; summary or detail information relating to sales from Electronic Photo Albums of other Members, including or limited to other Members to which it has referred the Web Site; and summary or detail information relating to sales from Electronic Photo Albums of each other Member who has designated it as such other Member's beneficiary.

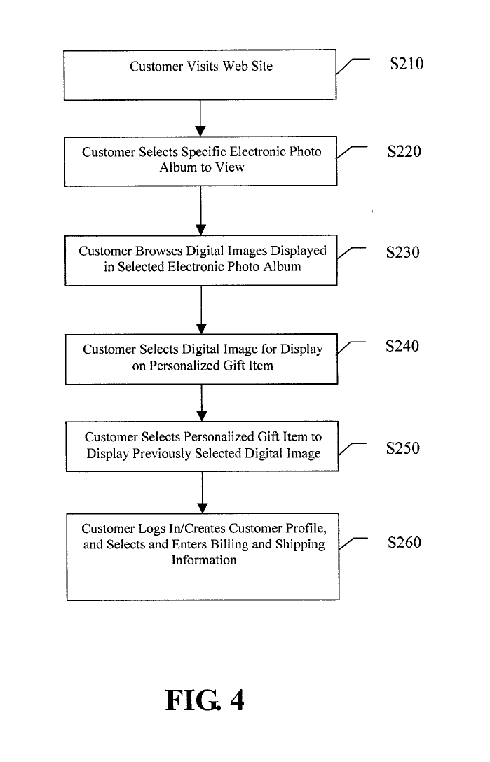

A description of Customer interaction with the Web Site of the preferred embodiments will now be described in reference to FIG. 4. As shown in step S210, a Customer visits the Web Site. Access to the Web Site is performed in a conventional manner using a commonly available web browser. In the preferred embodiment, the Customer is not required to register unless the Customer chooses to purchase Personalized Gift Items. In one embodiment of the invention, once a Customer has accessed the Web Site, the Customer is prompted to input the access code, to select a specific Electronic Photo Album to view S220. In this manner, a Member's Electronic Photo Albums are accessible only by Customers who know their access codes. This assists in maintaining privacy of the Member and protects Digital Images that are potentially private from being viewed by unauthorized Customers.

In an alternative embodiment of the Invention, a Customer may have unrestricted access to some or all Electronic Photo Albums created on the Web Site. Once a Customer has accessed the Web Site, that Customer may search for a particular Electronic Photo Album by, for example, performing a key word search or browsing through a displayed list of Members that may be classified by any number of categories, including, without limitation, type of Fundraising Entity, name of Member, name of Electronic Photo Album, or date or type of event. As an example of a key word search, a Customer might search for a particular Electronic Photo Album by entering into a search field the name of its hosting Member or the name or type of event at which the Digital Images for that Album were taken or collected. As an example of a search by category, a top level category list may be displayed for a Customer to select from, with such list to include, without limitation, “Private Persons,” “Non-profit Organizations.” A next level category under Non-profit Organizations may include for example, “Businesses,” “Schools” and so on. The layout and organization of Electronic Photo Albums and access thereto is determined in the discretion of the Web Service Provider and may be performed in any manner.

Once a Customer accesses an Electronic Photo Album, the Customer browses the Digital Images that have been uploaded to that album S230. In a preferred embodiment, several Digital Images are displayed as “thumbnail” size images and the Customer is able to click on each such thumbnail image in order to view it in larger detail. Any Customer that is so inclined may then order one or more Personalized Gift Items by selecting a Digital Image by, for example, first clicking on a button located near the image S240. Upon selecting a Digital Image, the Customer may be transported to the Electronic Store, which is a page or pages 12 within the Web Site containing all Personalized Gift Items then available for purchase. It should be recognized that the Electronic Store may also be at an entirely different site. The Customer may then select a particular Personalized Gift Items on which the selected Digital Image will be displayed S250. The Customer may then repeat this process of selecting Digital Images and shopping in the Electronic Store for Personalized Gift Items until such time as the Customer is ready to complete the purchase and proceed to checkout.

In order to complete a purchase, a Customer must first either login by entering certain identifying information (such as, for example, an email address and password) or, if the Customer is a first time purchaser from the Web Site, create a login profile S260. This step is necessary, as the Customer's billing and shipping information is required in order to complete an order. The login profile preferably includes the Customer's email address and a password that is unique to that Customer. The email address and password are used by the Web Site to allow it to identify the Customer upon return trips to the Web Site. In addition, the Member's email address may be used by either the Web Service Provider and/or the Member who has created the Electronic Photo Album from which the Customer's purchase is made to, for example, inform the Customer that new Digital Images have been posted to an existing Electronic Photo Album or that a new Electronic Photo Album has been created, in which case the access code for the new Electronic Photo Album may be supplied to the Customer.

The design and layout of the website, including inputs and responses, is discretionary with the Web Site designer and/or the Web Service Provider. Accordingly, the specific options described above are presented for facilitating a general understanding of the process and methodology of the present invention, and the present invention is not limited to these specific options.

An optional modification of the foregoing process and methodology is to enable a Customer to customize the Digital Image to be transferred to a Personalized Gift Item. For example, the Customer might select a size and format of the Digital Image to be transferred, including selecting a type and color of border. Moreover, the Customer may have the option of adding text to be transferred with the selected Digital Image (for example, “Spring Break '99”). Customization of Digital Images, specifically, and of any of the other image transfer services, generally, are limited only by technological constraints and one's imagination.

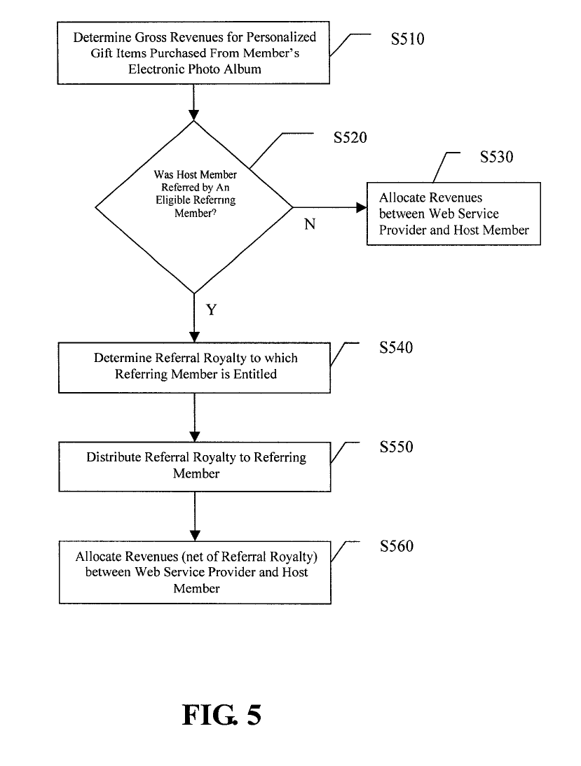

As previously mentioned, the Member, and/or a Fundraising Entity designated by the Member, is credited for and/or receives some or all of the revenues generated from the sale of Personalized Gift Items from that Member's Electronic Photo Albums. The portion of the revenues paid to, or as directed by Members, may be determined at the discretion of the Web Service Provider. Such portion of the revenues may be set as either a fixed or variable percentage of either gross revenues or of any measure of profits. If based on profits, the determination of profit might take into consideration and number of factors, including, without limitation, cost of goods sold and various fixed and/or variable costs, both direct and indirect, of providing the image transfer services and/or related services. Payments to Members or their designated beneficiaries are preferably made on a periodic basis (e.g., quarterly) as determined by the Web Service Provider. As an added incentive, some or all Members may be eligible to refer the Web Site to other Fundraising Entities. In this case, a referred Fundraising Entity registers as a Member, the referring Member, if eligible, receives a portion of the revenues generated from the sale of Personalized Gift Items from the Referred Entity's Electronic Photo Albums. FIG. 5 illustrates an example of this process.

For purposes of illustration, assume Member A refers the Web Site to Fundraising Entity B, and the Fundraising Entity B registers as a Member (“Member B”) and lists Member A as its referring organization. Further assume that Member B, as determined by the Web Service Provider, creates one or more Electronic Photo Albums from which Customers purchase, in the aggregate, ten thousand dollars of Personalized Gift Items (exclusive of shipping charges and sales tax) (the “Purchased Amount”) S510.

The Web Service Provider, which may utilize a software algorithm, then determines whether Member B was referred by an eligible Member S520. Eligibility is discretionary with the Web Service Provider and may take several factors into consideration, for example, whether Member A is a non-profit organization, etc. If Member B was not referred by an eligible Member, then the Purchase Price is allocated between the Web Service Provider and Member B according to whatever allocation formula is then in effect S530. However, in this example, assume Member A is an eligible referring organization. Therefore, the Web Service Provider determines the portion of the Purchased Amount to which Member A, as the referring Member, is entitled as a “referrer royalty” by applying the then applicable referral royalty percentage to the Purchased Amount S540. Such referral royalty is then paid by the Web Service Provider to the referring Member A, the referring Member in this example S550, and the remaining revenues (i.e., net amount after the referral royalty is substracted) is then allocated between the Web Service Provider and Member B S560.

The referral royalty percentage may be fixed or variable, and, if variable, may be determined based on any one or more of a number of factors, including, without limitation, the number of referrals made by the referring Member and the level of sales generated by the referred to Members. Following the example described above, if the deducted percentage is five percent, Member A (the referring entity) would be entitled to a referral royalty of $500 based on the gross revenues generated only from sales from Member B's Electronic Photo Albums. The remainder of the Member B revenues (i.e., $9,500) may be first applied by the Web Service Provider against costs and expenses and the balance allocated between the Web Service Provider and Member B based on whatever formula was then if effect S560. The skilled artisan will recognize that the accounting techniques used in determining distributed funds may vary, and thus the present invention is not limited to any specific type of revenue or profit accounting.

FIG. 6 illustrates an alternative method for distributing revenues generated by Members. This method is similar to that illustrated in FIG. 5, except that a referral royalty is automatically deducted from the Purchased Amount and either paid to the referring Member, if there is a referring Member, or to a default organization, if there is no referring Member. After determining the Purchased Amount S610, the Web Service Provider determines the portion of the Purchased Amount to which a referring organization is entitled as a referrer royalty by applying the then applicable referral royalty percentage to the Purchased Amount S615. The Web Service Provider then determines whether Member B listed another Member (in this example, Member A) as its referring organization S620 and, and, if it did, donates such referral royalty to the referring organization (Member A in this example) S650. On the other hand, if it is determined that Member B did not list another Member as its referring organization, or the referring organization is ineligible to receive referral royalties, then the referral royalty is donated to a “default” organization S632, which default organization may be either an entity established by or on behalf of the Web Service Provider or any other entity whether already existing or yet to be established. The Member B revenues remaining after reduction for the referral royalty may first be applied by the Web Service Provider against costs and expenses with the balance allocated between the Web Service Provider and Member B based on whatever formula was then if effect S660. It is worth noting that the revenues attributed to Member B may be forwarded to a beneficiary fundraising organization designated by Member B at the time of registration. For example, if Member B is an alumnus of a particular school, member B may register with the Web Service Provider and designate the school as the beneficiary of proceeds resulting from the sale of Personal Gift Items having Digital Images selected from Member B's Personalized Electronic Photo Album. Consequently, references in this disclosure, including the appended claims, of allocating or distributing revenues or finds to “the fundraising entity” or “registering entity” includes any beneficiaries that may be designated by individuals or organizations that are registered Members.

In one embodiment of the Invention, the Web Service Provider contracts with one or more third party vendors of Personalized Gift Items and/or for some or all of the image transfer services. In another embodiment of the Invention, the Web Service Provider produces all Personalized Gift Items and performs some or all of the other image transfer services in-house.

The methods described above may be incorporated into software such that inputs and output of the web site described above are performed in an automated manner. For example, commonly available HTML, picture management, and accounting software are customized and combined to allow implementation of the present invention on conventional processors and servers.

The inventor envisions that, to every extent possible, the methods and systems described herein: (i) may be performed in any sequence and/or combination; and (ii) the components of respective embodiments combined in any manner.

Although there have been described preferred embodiments of this novel invention, many variations and modifications are possible and the embodiments described herein are not limited by the specific disclosure above, but rather should be limited only by the scope of the appended claims.

What is claimed is:

1. A method for fundraising comprising:
registering a fundraising entity with a service provider;
displaying products for sale on a viewable medium hosted by the service provider;
selling a displayed product to a customer, wherein the product sold is adapted to display a personal image selected by the customer, the personal image relating to the registered fundraising entity; and
distributing, by the service provider, a portion of revenues from the product sold to the registered fundraising entity.

2. The method of claim 1 wherein before selling, the method further comprises:
displaying a plurality of personal images relating to the registered fundraising entity on the viewable medium including the personal image selected by the customer.

3. The method of claim 2 wherein the viewable medium comprises a website hosted on a web sever and accessed by a computer via the Internet.

4. The method of claim 3 wherein registering comprises:
receiving identification information for the fundraising entity;
creating at least one photo album for the fundraising entity; and
issuing an identifier for the created photo album to the fundraising entity for access to the created photo album.

5. The method of claim 4 further comprising:
providing the issued identifier to potential customers.

6. The method of claim 1 wherein distributing the portion of revenues to the registered fundraising entity comprises:
determining a purchased amount for the product sold displaying the personal image selected by the customer; and
distributing a percentage of the purchased amount to the fundraising entity.

7. The method of claim 1 wherein distributing profits to the registered fundraising entity comprises:
determining a purchased amount for the product sold displaying the personal image selected by the customer;
deducting a predetermined percentage from the purchased amount;
distributing a percentage of the purchased amount less the deducted percentage to the fundraising entity; and
distributing the deducted percentage to a different entity.

8. The method of claim 7 wherein the different entity comprises an entity that referred the fundraising entity to register with the service provider.

9. The method of claim 7 wherein the different entity comprises a default charity.

10. A computer program product including machine-readable code stored in a distributed storage medium comprising:
code for facilitating registering a fundraising entity with a service provider;
code for generating viewable images of products for sale on a viewable medium hosted by the service provider;
code for closing a sale to a customer to purchase a product adapted to display a personal image selected by the customer, wherein the personal image relates to the registered fundraising entity;
code for determining revenues from closed sales of products; and
code for allocating a portion of the determined revenues to the registered fundraising entity.

11. The computer program product of claim 10 further comprising:
code for displaying a plurality of provided personal images relating to the registered fundraising entity on the viewable medium; and
code for allowing the customer to select a personal image from the displayed plurality of provided personal images, to be displayed purchased products.

12. The computer program product of claim 10 wherein the code for allocating the portion or revenues comprises:
code for deducting a predetermined percentage of determined revenues from closed sales of products and allocating the predetermined percentage to a different entity; and
code for determining whether the registered fundraising entity was referred to the service provider by a referring fundraising entity.

13. The computer program product of claim 12 further comprising:
code that, when it is determined that the registered fundraising entity was referred, designates the referring registered fundraising entity as the different entity.

14. A method of hosting fundraising comprising:
providing a platform on which a host fundraising entity displays personal images;
offering a plurality of products for sale on which the displayed personal images may be incorporated; and
distributing to the host fundraising entity, a portion of revenues from products sold incorporating personal images from the host fundraising entity.

15. The method of claim 14 wherein the platform comprises a website hosted on a server computer.

16. The method of claim 15 further comprising:
registering a plurality of fundraising entities; and
providing incentives to a registered fundraising entity for referring additional fundraising entities to register.

17. The method of claim 16 further comprising:
distributing to a default charity, a portion of the revenues from products sold incorporating personal images from the platform.

18. A system for fundraising comprising:
means for registering a fundraising entity;
means for posting personal images selected by the registered fundraising entity;
means for viewing the posted personal images and selecting a desired personal image by a customer;
means for viewing and selecting products to display the desired personal image by the customer; and
means for determining revenues to be distributed to the registered fundraising entity.

19. The system of claim 18 wherein the means for registering, posting, and viewing comprise respective pages of an application program interface hosted by a computer server accessible over a communications network.

20. The system of claim 19 wherein the means for determining revenues comprises a processor in the computer server executing machine readable code.

21. A method for fundraising comprising:
registering an entity with a service provider, the entity comprising one of a fundraising entity, or any individual or organization on behalf of the fundraising entity;
displaying a plurality of personal images relating to the registered entity, on a web site hosted by the service provider;
displaying products for sale on the web site hosted by the service provider;
selling at least one displayed product to a customer, wherein each product sold is adapted to display an image selected by the customer from the plurality of personal images;
allocating revenues generated from the sale of products between the service provider and at least one of the registered entity and a different party other than the registered entity and the service provider; and
providing the registered entity access to reports of at least one of sales and viewing activity relating to the personal images relating to the registered entity.

22. The method of claim 21 wherein registering comprises:
receiving identification information of a registering entity;
creating at least one photo album for the registering entity; and
issuing an identifier to the registering entity to identify the created photo album.

23. The method of claim 22 further comprising:
providing the issued identifier to prospective viewers of the photo album for which such identifier has been issued.

24. The method of claim 21 wherein allocating revenues comprises:
deducting a royalty, using a predetermined royalty percentage, from the revenues generated from the sale of products attributed to the registered entity;
distributing the royalty to a different entity other than the service provider and the registered entity;
allocating the revenues less the royalty between the service provider and the registered entity; and
distributing the allocated revenues.

25. The method of claim 24 wherein the royalty comprises a referral royalty and the different entity comprises a referring entity that referred the registered entity to the web site hosted by the service provider.

26. The method of claim 24 wherein the different entity comprises a default entity selected by the service provider.

27. The computer program product of claim 10 wherein the code for allocating a portion of the determined revenues comprises:
code for determining a referral royalty to be deducted and distributed to one of a referring fundraising entity and a default entity selected by the service provider; and
code for allocating the revenues less the referral royalty between the service provider and the registered fundraising entity.
